(19) United States
(12) Patent Application Publication
(10) Pub. No.: US 2008/0221966 A1
(43) Pub. Date: Sep. 11, 2008

(54) APPARATUS, SYSTEM, AND METHOD FOR ENABLING USER-FRIENDLY, INTERACTIVE COMMUNICATION AND MANAGEMENT OF CARTAGE TRANSACTIONS

(76) Inventor: Ragnar H. Backsen, Westminster, CO (US)

Correspondence Address: Kunzler & McKenzie, 8 EAST BROADWAY, SUITE 600, SALT LAKE CITY, UT, 84111, US

(21) Appl. No.: 12/036,127

(22) Filed: Feb. 22, 2008

Related U.S. Application Data
(60) Provisional application No. 60/891,161, filed on Feb. 22, 2007.

(51) Int. Cl. G06Q 10/00; G06Q 20/00; G01C 21/00; H04M 1/00

(52) U.S. Cl. 705/9; 705/1; 701/200; 455/569.2

(57) ABSTRACT

An apparatus, system, and method are disclosed for cartage management, optimized for the needs of the individual operator while scalable to handle the largest cartage operation. The system is based on a distributed computing and communications network, with an integrated user interface running on a mobile console providing a single point of control for cartage applications, and other peripheral devices including a biometric device, a navigational device, and a printer/scanner. The cartage applications are further integrated via a common database, and a mechanism whereby information produced by one cartage application may be programmatically consumed by another cartage application, thus enabling the cartage applications to operate as a cohesive whole.

### CROSS-REFERENCES TO RELATED APPLICATIONS

This application is a continuation-in-part of and claims priority to U.S. Provisional Patent Application No. 60/891,161 entitled “APPARATUS, SYSTEM AND METHOD FOR ENABLING USER-FRIENDLY, INTERACTIVE COMMUNICATION AND MANAGEMENT OF CARTAGE TRANSACTIONS” and filed on Feb. 22, 2007 for RAGNAR H. BACKSEN, JR., which is incorporated herein by reference.

### BACKGROUND OF THE INVENTION

1. Field of the Invention

This invention relates to the capture, control and management of cartage-industry operator wireless communication functions and transactions, and more particularly, relates to portable wireless electronic apparatus, system and methods that facilitate tasks common to the operator of a commercial vehicle that provides cartage, transport and haulage services.

2. Description of the Related Art

Commercial cartage, transport and haulage services are traditionally provided by drivers, operators, truckers or pilots of commercial vehicles. The services rendered include the transport and delivery of goods, freight, and substances to specific locations indicated by a delivery manifest.

For instance, an operator of a diesel truck, commonly referred to as a trucker, is often required to pick up freight from several sources, deliver it to multiple locations, and follow specific routes determined by elevation and high load values.

These transport services, tend to be highly regulated by state, provincial, and national legislation. As a consequence, the large amount of administrative and compliance paperwork becomes burdensome to submit while simultaneously having to perform the aforementioned services.

The trucker may be an independent operator or belong to a small, medium or large trucking organization. Reports show that the overwhelming majority of the industry is serviced by entities having ten or less trucks. About half of the industry is supported by operators of only one truck. Larger organizations have greater capacity to support the scheduling, management and compliance requirements of the industry and render greater support services to the trucking process. As a consequence, larger organizations are able to transport the more profitable loads.

The major elements and participants in the trucking process include trucking management organization(s), dispatcher(s), a brokerage or broker, a truck, a trucker, freight to be transported, a supplier of the freight, the receiver of the freight, lumper or dock personnel provided by a third party, loading, unloading and transport vehicle maintenance, bills of lading, accounting, fuel and supplies, taxes, a communication capability between all parties, proof of regulating legislation compliance, and a manual or automated record management system.

Tools that facilitate the process traditionally have been provided by larger trucking organizations to their fleet of trucks and drivers. Such tools include computer systems and software in addition to many manual, and mechanical, recording techniques. Such tools optimize productivity of the critical resources and assets, and provide a higher return on investment for the organization. Larger organizations have achieved a greater degree of integration of the various tools, but even then, the tools are very expensive, tend to be non-integrated, and frequently are supplied by separate software vendors.

The operator needs a way to better manage his current transport assignment in the context of his complete life: in the truck, managing the truck and load, in his office, personal needs, and at home. Simply stated, there is a need for all tools to be packaged in a user-friendly device that will allow small operators to compete with big operators. Small operators cannot afford the costly tools that are available, nor the cost of satellite tracking that qualifies him for transporting higher value loads at greater profit.

A suitable tool would be robust, easy-to-use, require minimal user training and be scalable for use by small to large organizations. It would also provide an operator with the apparatus to facilitate the capturing and provisioning of all necessary management data and report generation.

### SUMMARY OF THE INVENTION

From the foregoing discussion, it should be apparent that a need exists for an apparatus, system, and method that intuitively and cost-effectively enable the total management of cartage operations in a fully integrated fashion. Beneficially, such an apparatus, system, and method would conform to the daily schedule and tasks of the individual operator, while scaling seamlessly to support all of the cartage operations for an entire organization deploying a fleet of any size.

The present invention has been developed in response to the present state of the art, and in particular, in response to the problems and needs in the art that have not yet been fully solved by currently available cartage management systems. Accordingly, the present invention has been developed to provide an apparatus, system, and method for cartage management that overcome many or all of the above-discussed shortcomings in the art.

The combined attributes of user-friendliness and scalability may be most efficiently achieved in a distributed computing and communications environment, over a network such as the internet. Cartage customers and brokers are largely becoming internet-based as well, which in conjunction with the present invention would permit even the smallest cartage operation including the individual proprietor to better leverage the available opportunities. Customer loads are available on the internet, to which individual operators may respond, either singly for smaller customers, or through a broker-based coop for larger customers, especially as the present invention gains wider acceptance within the industry. A network-based approach allows vast resources, including telecommunications, server farm(s), and database storage, to be made available to the individual user on a SaaS (Software as a Service) subscription basis via a mobile console, such as a PDA, smart phone, notebook computer, or an OEM embedded computer system within the truck synchronized with a PDA and/or smart phone. The availability of inexpensive navigational technology, such as GPS, either built into the mobile console or as a separate peripheral device, is also a key element of the present invention.

The mobile console provides a platform for the implementation of an integrated user interface, providing a single point of control for all of the necessary cartage applications. The interface is designed primarily for the convenient daily use of the individual operator (e.g. trucker), but is equally well-suited to centralized management operations such as dispatching, and to third parties including customers and brokers on a restricted basis via appropriate permission settings via a secure web interface.

For added reliability, the mobile console may be periodically backed up by synchronization with the central database. This is done automatically, typically every 30 to 60 minutes, so as to keep the back-up copy sufficiently current while minimizing any interruption to the user. During this synchronization process the mobile console is also updated with any updates or software changes.

Navigational data, including location and speed, is also captured and stored in the database at regular intervals, typically every 2 minutes. An SMS (text messaging) facility is used for this purpose, since it is always on, does not interfere with other user activity including phone communication, and can easily handle the limited amount of data involved. This approach is much more cost-effective than prior art systems which require a satellite uplink to transfer such information. An additional advantage of SMS is that it remains operative even when connectivity to the network is marginal.

In a further embodiment, dispatching information may also be sent to the mobile console via SMS, allowing the user to select one of several available loads, with that choice automatically being communicated back via the same SMS facility.

In addition to an integrated front end provided by the comprehensive user interface, the cartage applications are also integrated at the back end via the database, with programmatic transfer of information between the applications in real time, thereby allowing them to operate as a cohesive whole. The term ‘programmatic’ as used herein is meant to include both fully automatic operation, as well as optionally querying the user as to whether or not the transfer of information between applications should be made.

Numerous possibilities exist for cartage application integration. One key application is the daily log, into which the user enters information related to various activities including change of duty status (on/off duty, driving, sleeper berth), and vehicle inspections. Navigational application information may be programmatically transferred into the log, such as miles driven in different jurisdictions, as well as accounting application information, such as refueling transactions, allowing the amount of fuel consumed and taxes paid or owed in the various jurisdictions to be automatically calculated and logged as required by IFTA. The user may also elect to log the information manually. The odometer mileage between fuel stops and maintenance may also be automatically tracked, providing useful information for data mining.

The navigational application may also receive information programmatically from other cartage applications. Dispatch destination information may be received from a management application. Fuel usage information from an accounting application, combined with updated fuel pricing obtained over the internet, may be used to optimize routing and fuel stops. Other information that can be integrated from remote sources would include road conditions, tolls and weight restrictions for certain roadways, the location of truck stops and rest areas along the way, targeted advertising for various goods and services providers along the route, and alerts for various conditions, such as average speed approaching a specified limit. The net result is a very rich GPS interface that is highly optimized for the needs of the cartage operator.

Reporting, especially for regulatory purposes, is another very important application. Information can be drawn programmatically from various other cartage applications to populate a report, such as work shift data from the daily log, and fuel cost information from the accounting application.

Management applications may also programmatically receive information from other applications. For example, there are regulations limiting driving to 11 hours a day of the 14 on-duty hours available, and requiring 10 hours off-duty with at least 8 of those hours taken consecutively, as well as a 34-hour reset every 70 hours. Work shift data from the daily log application can be compared with these limits by the management application, and inform the dispatcher whether a given driver is available to be dispatched.

Accounting applications may also programmatically receive information from other applications. For example, mileage from a navigational application permits a determination of how much a given load pays per mile, after deducting brokering and factoring overhead. Work schedule information from the daily log application permits a per diem allowance to be determined, resulting in significant income tax savings.

In an embodiment, the apparatus includes a touch screen display. This is particularly useful in capturing a signature. The driver's signature may be obtained for each daily log, which is a regulatory requirement, as reusing a scanned copy of the same signature is not permitted. The signature of a receiving customer may also be obtained for the Q-Load (quick load) system, simultaneously informing the shipper and factoring company, thereby allowing electronic payment to be received within 24 hours. That is a major improvement over the prior art Trip-Pack system, which can cost $150/month, and requires the billing paperwork to be sent overnight by DHL, followed by 1-2 days for a scanning facility to scan it and send it off for eventual payment several weeks later.

In another embodiment, the system includes printer/scanner. Such a device U allows documents to be scanned, such as fuel receipts for tax return documentation, or lumper receipts at the receiving dock, for reimbursement by the shipper. The printing capability would allow daily logs to be printed upon demand at truck scales, and reports to be printed right off the truck as needed, or at the web-based back office.

With the degree of automation disclosed above, the present invention would meet all of the currently proposed requirements for EOBR (Electronic On-Board Recording), at a fraction of the cost. It would also fully support the tracking of rental trucks, as proposed for homeland security. Even further automation is possible. One possibility would be remotely monitoring the load, such as the ripeness of produce being transported, sensing the vehicle status, such as air pressure, and monitoring and adjusting various controls, such as the refrigeration thermostat. Another possibility would be paperless transactions, such as by a wireless connection from a point-of-sale terminal such as a fuel pump, or by email-based receipts. Kiosks in strategic locations such as truck stops could be deployed, to perform such functions as reloading data into a replacement for a mobile console which was lost or damaged.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts a distributed computing and communication system based upon a network.

FIG. 2 depicts one embodiment of a mobile console.

FIG. 3 depicts one embodiment of a mobile console with a mini keyboard in an extended position.

FIG. 4 depicts a cradle holding a mobile console so as to permit hands-free operation.

FIG. 5 depicts one embodiment of a biometric device.

FIG. 6 depicts one embodiment of a navigational device.

FIG. 7 depicts one embodiment of a printer/scanner.

FIG. 8 depicts a software stack running on the system.

FIG. 9 depicts one embodiment of unified user interface for cartage applications.

FIG. 10 depicts a user interface for a driver daily log cartage application.

FIG. 11 depicts a user interface for an expense manager cartage application.

FIG. 12 is a flow chart illustrating a programmatic transfer of information between cartage applications.

FIG. 13 is a flow chart illustrating a method for using the present invention, either while traveling or while stopped.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

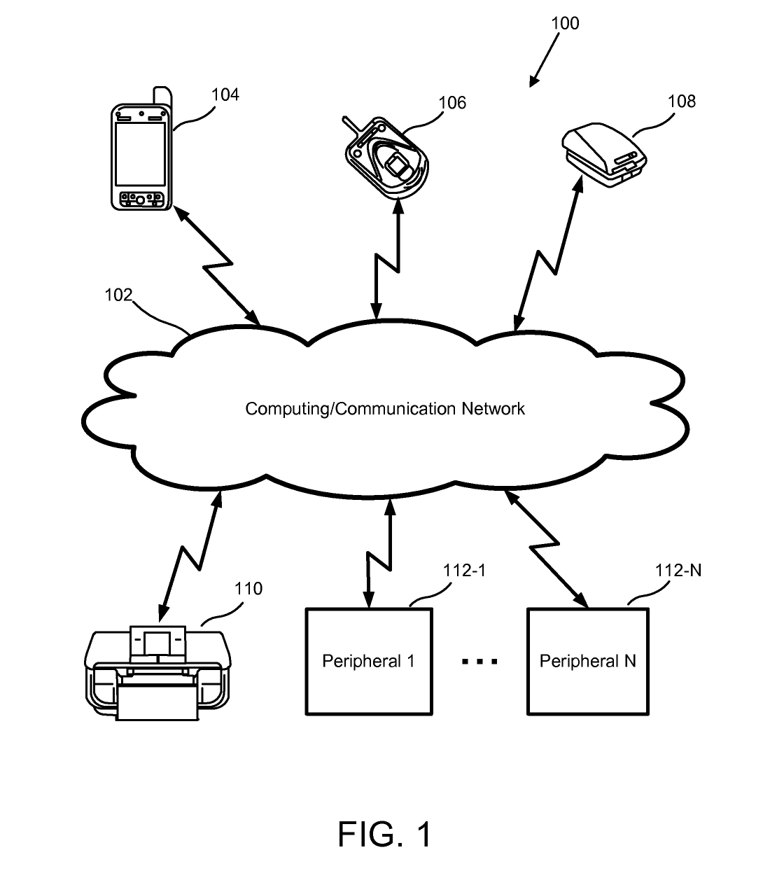

FIG. 1 depicts a distributed computing and communication system 100 based upon a network 102. Connected to network 102 are a variety of devices, including a mobile console 104, biometric device 106, navigational device 108, printer/scanner 110, and other peripheral devices 112-1 to 112-N.

In one embodiment, peripheral devices 112 may comprise an entertainment and educational apparatus, including a video display device, keyboard device, digital video recorder (DVR), hard disk drive device, DVD/CD reader/writer, USB hub and connector device, and audio and speaker device.

The video display device, in one embodiment, is a flat-panel LCD or plasma device that can be used in various locations in the vehicle for viewing video or digital information.

The keyboard device can be used in the entertainment and educational apparatus or in conjunction with the mobile console 104 to more easily enter a larger quantity of data into the system 100.

The digital video recorder DVR and hard disk drive device provides mass storage capability for all functions of the system 100.

The USB hub and connector device provides connectivity of all devices that communicate via USB such as the printer/scanner 110, the navigational device 108, and the biometric device 106, DVR, and DVD/CD.

The audio and speaker device provides quality digital or analog sound capability.

In one embodiment, peripheral devices 112 may comprise a physical security apparatus, including external-rig video cameras, internal-cab video cameras, and a laser perimeter fence that establishes a protected ring around a vehicle that facilitates intrusion detection.

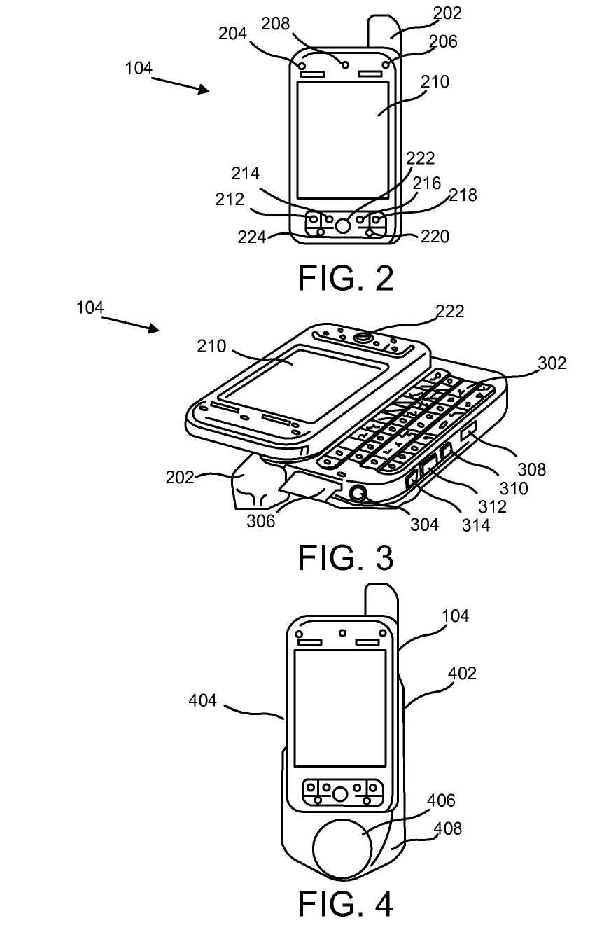

FIG. 2 depicts one embodiment of a mobile console 104, specifically, a Sprint PPC 6700 cell phone, with antenna and stylus 202, cursor left LED 204, cursor right LED 206, speaker 208, touch screen display 210, left soft button 212, START button 214, OK button 216, right soft button 218, END button 220, cursor control 222, and TALK button 224.

FIG. 3 depicts one embodiment of a mobile console 104 with a mini keyboard 302 in an extended position. Also visible in this view are on/off switch 304, mini/micro SD memory slot/card 306, IR detector 308, browser button 310, volume control 312, and voice recorder control 314.

FIG. 4 depicts a cradle 402 holding mobile console 104 so as to permit hands-free operation. As used herein, the term “hands-free” is intended to mean that it can be used without the use of hands (for example via voice commands) or, in a wider sense, needs only limited use of hands, or for which the controls are positioned so that the hands are able to occupy themselves with another task (such as driving) without needing to hunt for the controls. The cradle 402 does not preclude hands-on operation of the mobile console 104 where appropriate. All of the controls described in FIGS. 2 and 3 remain accessible, including mini keyboard 302 which may be extended through cradle keyboard access 404. However, much of the functionality of mobile console 104 may be controlled in a substantially hands-free manner with cradle multifunction button 408, which is large and prominently positioned on the front of cradle 402 to permit easy access. Cradle 104 also has external speakers (not shown) to permit output in the form of speech synthesis, and a remote microphone jack (not shown) to permit input in the form of speech recognition, thereby enabling fully hands-free operation.

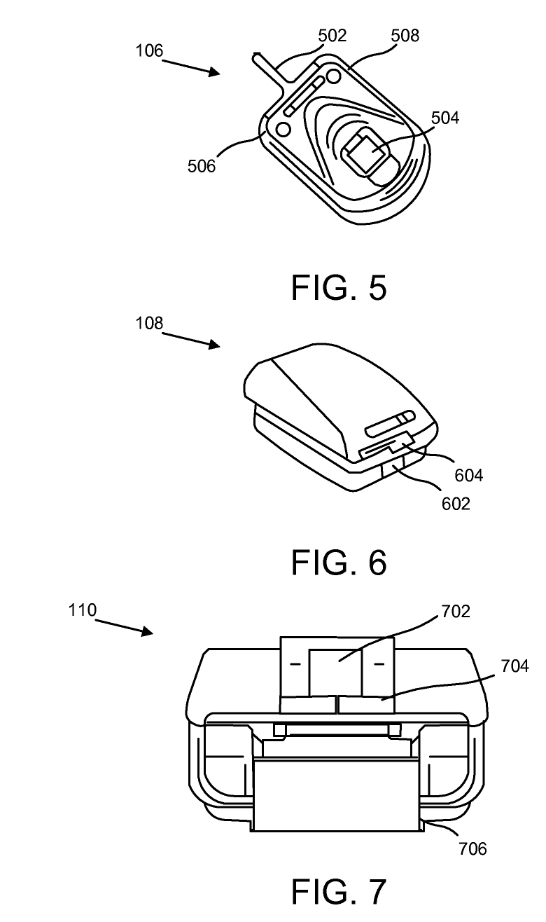

FIG. 5 depicts one embodiment of a biometric device 106, specifically, a fingerprint reader. It is connected to network 102 via cable 502. The user places their fingertip on the sensor platen 504. Successful authentication is indicated by the illumination of green indicator light 506. Failure is indicated by red indicator light 508 flashing, which otherwise remains illuminated when there is power to the device.

In another embodiment, the biometric device 106 may use iris scan, voice print, DNA, or other biometric parameters to authenticate the identity of a user of system 100.

In a further embodiment, the biometric device may use Public Key Infrastructure secure storage media such as cryptographic dongles.

FIG. 6 depicts one embodiment of a navigational device 108, specifically, a GPS device. It is activated via GPS on/off switch 602. GPS indicator light 604 is amber while charging and alternates between blinking green and blue while in use.

There may be a multiplicity of navigational devices 108 attached to vehicles or load components.

The navigational device 108 allows vehicles or load components to be tracked by satellite and communicate location and destination information to the mobile console 104 and to distributed and centralized operations of the system 100.

FIG. 7 depicts one embodiment of a printer/scanner 110. Pop-up monitor 702 allows the image to be previewed and enhanced if necessary prior to printing, and when in the open position also makes control panel 704 accessible to the user. Paper output tray 706 is where the printed document appears.

Printer/scanner 110 functions by Bluetooth, USB, WiFi, or IR data connection with the mobile console 104.

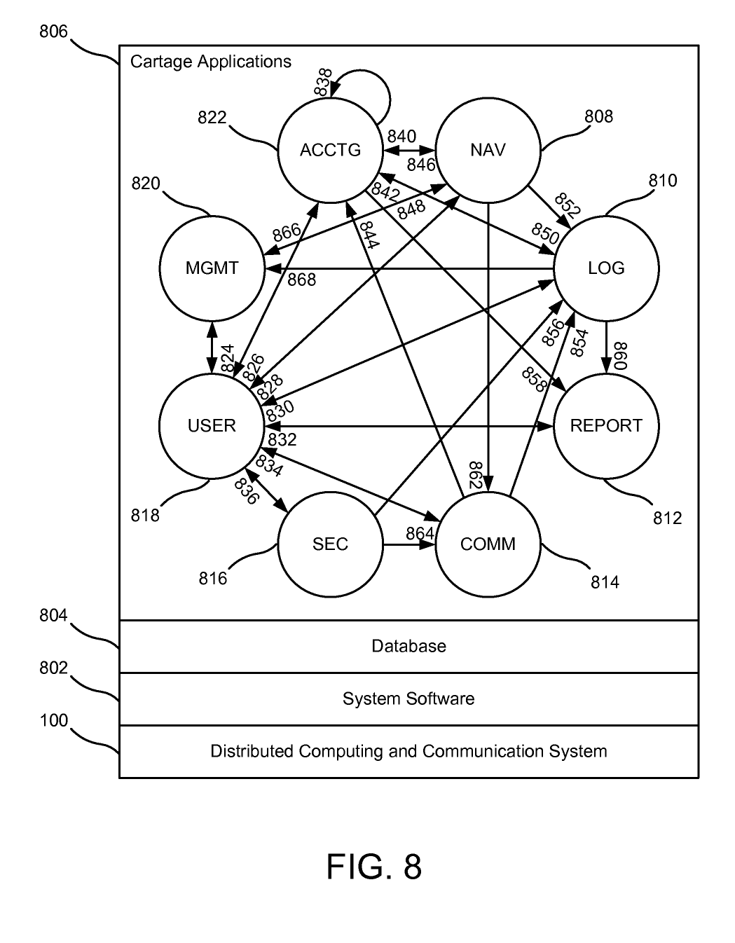

FIG. 8 depicts a software stack running on the system 100. System software 802 provides the basic enablement of the hardware components of system 100 as heretofore described. Database 804 is a key middleware component within the basic environment provided by system software 802, providing a central repository for the data generated and utilized by the cartage applications 806. The cartage applications 806 may be best understood by categorizing them into several major groups.

Navigational applications 808 comprise one group of cartage applications 806. The GPS module allows the mobile console 104 to accept both voice and keyboard commands to determine the geographical location via satellite for a given navigational device 108. Driving directions for load pickup or delivery may be supplied to the user both graphically and audibly via the mobile console 104. A GPS routing and fencing module facilitates locating a correct travel route using Road Finder logic. Selecting specific points of interest such as restaurants, hospitals, and so forth is an additional feature. A road/highway travel conditions module may provide current information on road conditions using Road Alert artificial intelligence logic. Additional navigational applications 808 include a load tracking module, and a traffic control module.

Logbook applications 810 comprise one group of cartage applications 806, including a driver log module, and an equipment maintenance log module.

Reporting applications 812 comprise one group of cartage applications 806. A report module must meet Department of Transportation requirements regarding driver logs with specific text colors and daily submission in PDF format. A report generator module may utilize Crystal report writer.

Communications applications 814 comprise one group of cartage applications 806. A messaging module may provide text-messaging and email. A communication coordination module may provide all communication with home, office and others. Additional communications applications 814 include a communications module.

Security applications 816 comprise one group of cartage applications 806. The biometric authentication module allows the mobile console 104 to authenticate the identity of a user of the system 100. This authentication, along with a built-in security chip of the mobile console 104, and a PIN security code, provides a three-factor identity authentication for anyone accessing the system 100. Specifically, this provides something you are (biometric), with something you have (security chip), and something you know (PIN code).

The other ID authentication module is provided to implement four-factor authentication where required for highly secure cartage operations. An example of this is a digital certificate issued in accordance with the policies of Public Key Infrastructure. All forms of crypto-devices such as dongles and USB-drives may be used. The cryptoengine module provides the capability to encrypt, decrypt and digitally sign specific transactions. It also provides for the usage of digital certificates. The ability is provided to encrypt and decrypt data on the mini/micro SD memory card 306, any mass storage device such as the digital video recorder DVR and hard disk drive device, or data at rest in the database 804. It facilitates maintaining the confidentiality of all specified data at rest and during transmission to and from the mobile console 104 or any distributed nodes of operation of the system 100. A load alert module may use artificial intelligence logic to provide GPS time-to-delivery projections and generate tracking messages to multiple recipients. The physical security module provides the program support for devices such as video cameras and a laser perimeter fence. Functions such as arming, disarming, intrusion detection, maintenance and testing are included. It monitors the physical security of the vehicle and gives dynamic video and status feeds to central operations in addition to the vehicle operator.

User applications 818 comprise one group of cartage applications 806. In one embodiment, the mini/micro SD memory card 306 contains a user interface module that runs on the mobile console 104. The printing and scanning module allows the printing of reports and scanning of documents by the mobile console 104. This module supports connectivity between the mobile console 104, and the printer/scanner 110 by means of Bluetooth, USB, WI-FI or IR communication in vehicles or any other system 100 operations location. A document scanning module may process receipts on various forms of paper and thermal paper and extract meaningful data. Bills of Lading and fuel receipts are examples of such documents. A driver preferences profiles module may store driver-specific parameters, reports, security, personal information, healthcare and driving parameters. An education module may provide available resources for continuing education opportunities and items of general educational interest. A TV module may coordinate entertainment and continuing education, video feeds from office, home and so forth. Live TV access may be provided. A website module may provide the ability to create and maintain a personal driver or company website.

Management applications 820 comprise one group of cartage applications 806. A scheduling module may assist in identifying places to fuel, avoid and so forth. Additionally, it may provide dispatch information, delivery time, routing and so forth. A data mining module may collect management data on all features. Additional management applications 820 include a dispatch module.

Accounting applications 822 comprise one group of cartage applications 806. A driver accounting module may allow an owner-operator or company driver to continuously and periodically pull information from a given vehicle and driver to meet corporate and Department of Transportation requirements. A settlement module may provide a driver with settlement sheet of deliveries and provide input for the payroll module. Drivers are paid for pickups, drops, wait time and so forth. A major accounting package interface module may provide an interface for a commercial software package such as Quicken Books, PeachTree, Dynamics, MS Small Business, BusinessWorks, MAS90, Simply Accounting, Advantage and ACCPAC. A personal financial management module may provide the capability for a user to pay bills online and maintain a current financial analysis and statement. An interface with Quicken and other accounting software may be provided. Additional accounting applications 822 include a customer/vendors/brokers module, an accounts receivable module, an accounts payable module, a payroll module, an invoicing module, a personal/business income tax preparation module, and a driver expense report module.

The cartage applications 806 are highly integrated, communicating via the common database 804 at the back end, and a unified user interface running on mobile console 104 at the front end. Management user interface 824, accounting user interface 826, navigational user interface 828, logbook user interface 830, reporting user interface 832, communications user interface 834, and security user interface 836 are all brought together at the user interface module within the user applications 818.

The back-end integration is implemented on application-specific basis, wherein data produced by one application is programmatically consumed in real time by another application. Within the accounting applications 822, the personal/business income tax preparation module may consume income information 838 from the payroll module. The accounting applications 822 may also consume mileage information 840 from navigational applications 808, hours worked and maintenance cost information 842 from logbook applications 810, and air time cost information 844 from communication applications 814. The navigational applications 808 may consume fuel cost and toll road information 846 from accounting applications 822, and dispatch destination information 848 from management applications 820. The logbook applications 810 may consume fuel cost information 850 from accounting applications 822, route, speed, and stop location information 852 from navigational applications 808, call time information 854 from communications applications 814, and driver login/logout information 856 from security applications 816. Reporting applications 812 may consume financial report information 858 from accounting applications 822, and work shift information 860 from logbook applications 810. Communication applications 814 may consume caller location information 862 from navigational applications 808 and caller ID information 864 from security applications 816. Management applications 820 may consume routing information 866 from navigational applications 808 and driver availability information 868 from logbook applications 810.

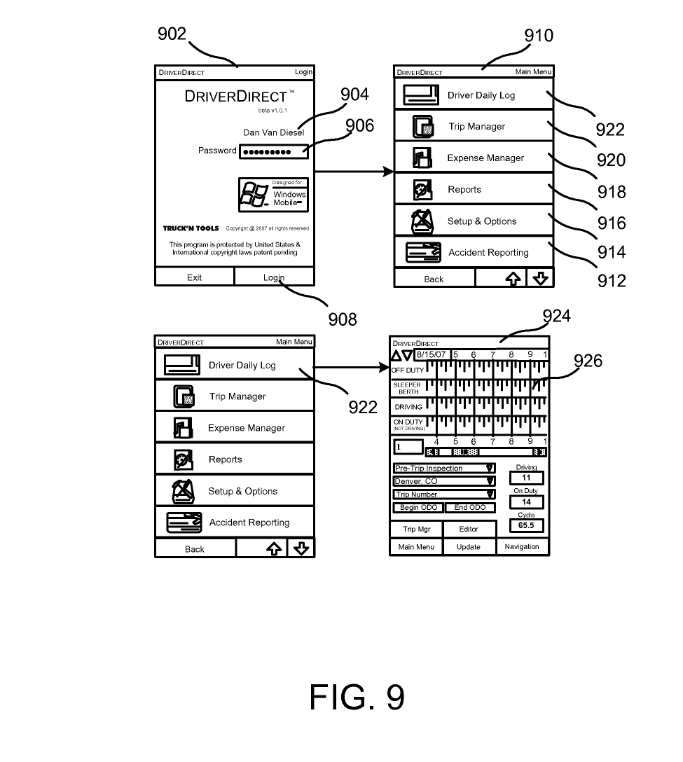

FIG. 9 depicts one embodiment of unified user interface for cartage applications 806. The screenshots shown are such as might appear on the touch screen display 210 of mobile console 104. The user is initially presented with a login screen 902, personalized with user name 904. Upon entering password 906 and pressing login button 908, login screen 902 is replaced by main menu 910 on touch screen display 210. Main menu 910 is populated with buttons for selecting among cartage applications 806, including accident reporting button 912, setup & options button 914, reports button 916, expense manager button 918, trip manager button 920, and daily driver log button 922. Upon pressing daily driver log button 922, daily driver log main screen 924 is presented, in which the daily driver log timeline 926 is prominently displayed, allowing the user to see at a glance the time spent off duty, in the sleeper berth, driving, or on duty but not driving.

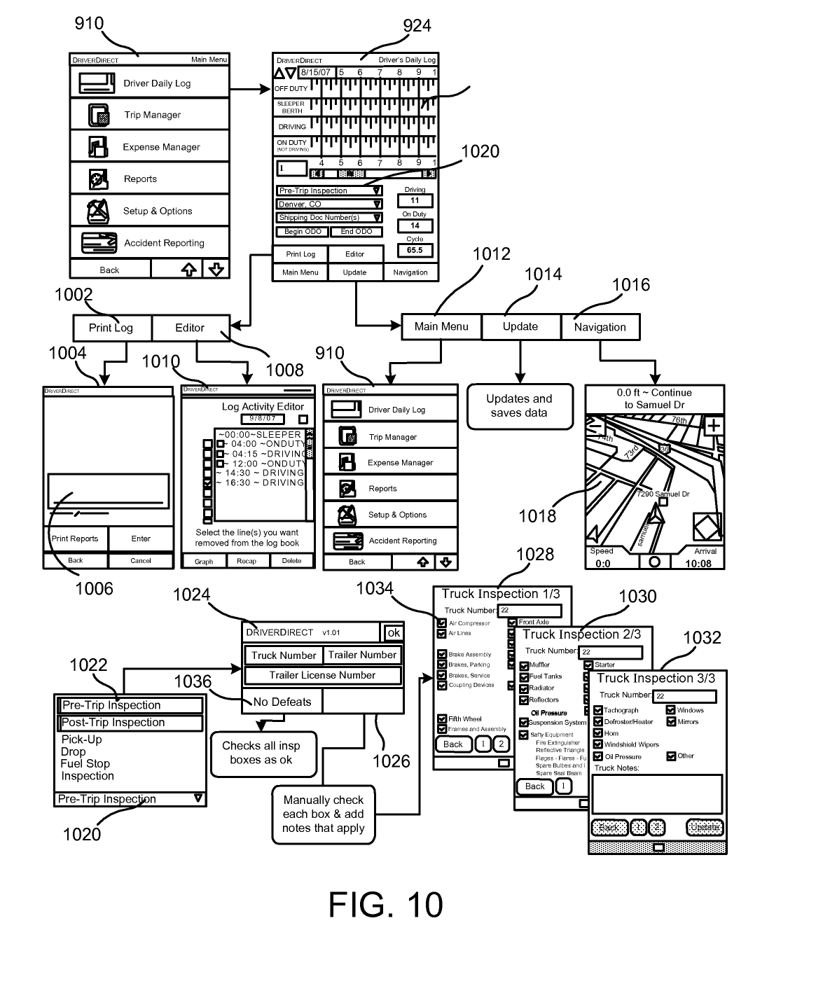

FIG. 10 depicts a user interface for a driver daily log cartage application. There are strict legal requirements for cartage logging, with stiff fines for non-compliance, even for minor clerical errors. The driver daily log application greatly facilitates error-free logging. There are a number of buttons and fields available on driver daily log main screen 924. Pressing print log button 1002 on driver daily log main screen 924 brings up print log screen 1004. Here the user may sign on signature line 1006 before printing an official log report to submit to authorities. Pressing editor button 1008 on driver daily log main screen 924 brings up log activity editor 1010 where log entries may be viewed and edited. Edits need not be logged if there is no regulatory requirement to do so for auditing purposes. Pressing main menu button 1012 on driver daily log main screen 924 returns the user to main menu 910. Pressing update button 1014 on driver daily log main screen 924 updates and saves the data. Pressing navigation button 1016 on driver daily log main screen 924 brings up interactive map 1018 which dynamically shows the vehicle location, route, speed, and other navigational information. Accessing the pop-up menu for task field 1020 and pressing pre-trip inspection button 1022 therein opens dialog box 1024. Pressing DVR button 1026 in dialog box 1024 accesses first inspection checklist 1028, second inspection checklist 1030, and third inspection checklist 1032. As the vehicle is inspected, each item in each checklist may be checked off in the corresponding checkbox 1034. Alternatively, the user may press no defects button 1036 in dialog box 1024 at the conclusion of a successful inspection, thereby simultaneously checking off all checkboxes 1034.

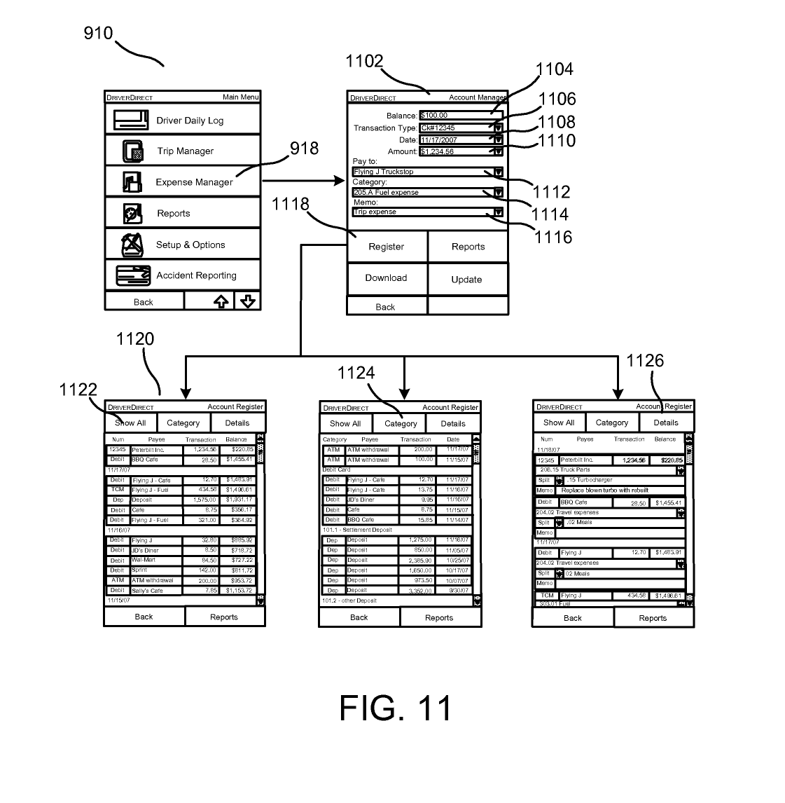

FIG. 11 depicts a user interface for an expense manager cartage application. This application is integrated with other cartage applications 806 so as to avoid having to do any redundant data entry with the attendant inconvenience and potential for error involved. For example, a refueling transaction in the expense manager will be reflected in the driver daily log via a programmatic transfer of fuel cost information 850. Pressing expense manager button 918 on main menu 910 brings up expense manager main screen 1102. The current balance 1104 is displayed at the top of the screen. The user may enter a transaction, filling in the fields provided for the transaction type 1106, date 1108 (defaults to current date), amount 1110, payee 1112, category 1114, and memo 1116. Pressing register button 1118 on expense manager main screen 1102 brings up account register 1120. Pressing show all button 1122 on account register 1120 causes all transactions to be displayed in chronological order, in summary form with one transaction per line. Pressing category button 1124 on account register 1120 causes the transactions to be sorted by category. Pressing details button 1126 on account register 1120 displays each transaction in an expanded form on multiple consecutive lines with all of the information associated with that transaction.

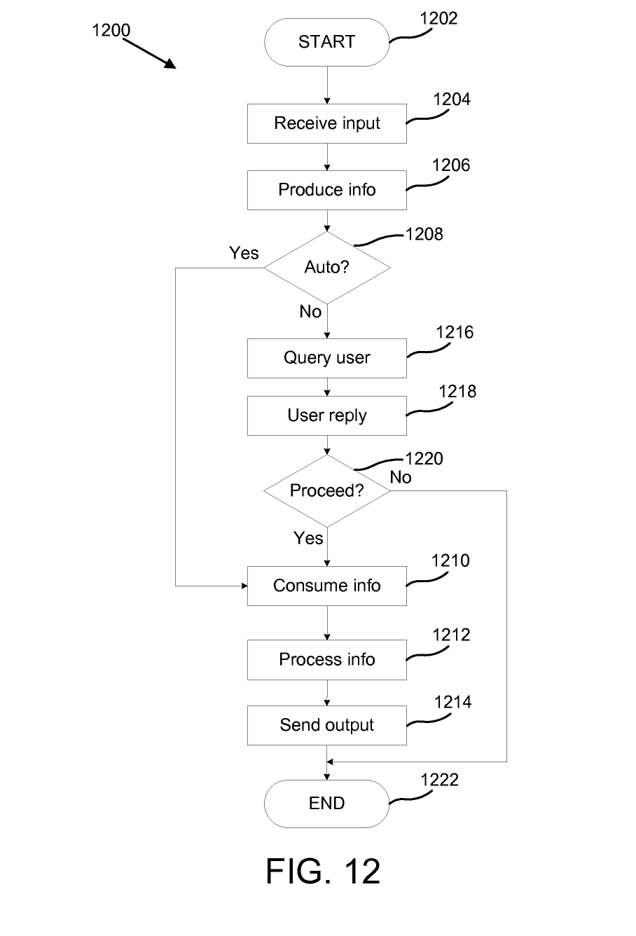

FIG. 12 is a flow chart illustrating a programmatic transfer of information between cartage applications 806. The method 1200 starts 1202 and a first cartage application 806 receives 1204 input from a user and produces 1206 information. If the information is to be transferred automatically 1208, then a second cartage application 806 consumes 1210 the information in real time, processes 1212 the information as appropriate, sends the resulting output 1214 to the user in due course, and the method 1200 ends 1222. If the information is not to be transferred automatically 1208, then the user is queried 1216 whether or not transfer the information. If the user reply 1218 is to proceed 1220, then the foregoing steps are performed starting with the step of consuming 1210 the information. If the user reply 1218 is not to proceed 1220, then the method 1200 ends 1222.

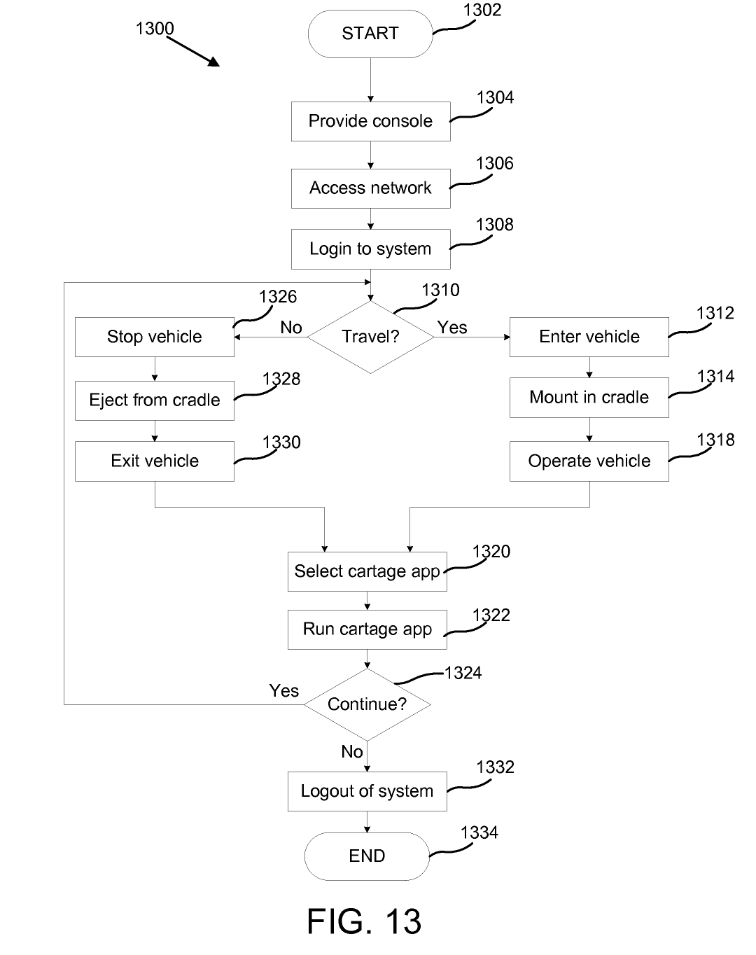

FIG. 13 is a flow chart illustrating a method for using the present invention, either while traveling or while stopped. The method 1300 starts 1302 and a mobile console 104 is provided 1304. The mobile console 104 accesses 1306 the network 102 and the user logs in 1308 to the system 100. If the user decides to travel 1310, then the users enters 1312 the control compartment of a vehicle, detachably mounts 1314 the mobile console 104 into a cradle 402 so as to permit substantially hands-free operation of the mobile console 104 while simultaneously operating 1318 the vehicle. The user selects 1318 a cartage application 806 via main menu 910, thereby bringing up an interface for cartage application 806. The user then runs 1322 cartage application 806 using the interface thus selected 1320. When cartage application 806 has been completed, the user may decide to continue 1324, repeating the foregoing steps starting with the step of deciding whether to travel 1310. If the user decides not to travel 1310, then the user stops 1326 the vehicle, ejects 1328 the mobile console 104 from the cradle 402 so as to permit handheld operation of the mobile console 104 after exiting 1330 the vehicle, starting with the foregoing step of selecting 1320 a cartage application 806. If the user decides not to continue 1324, then the user logs out 1332 of the system 100 and the method 1300 ends 1334.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for hosting cartage logging and applications, the system comprising:
a mobile console configured to communicate over a network in a distributed computing and communications environment including other peripheral devices;
a database communicable with the mobile console;
a navigational device in communication with the mobile console;
a logging module configured to communicate with the navigational device and with a user and to log cartage data in the database;
a plurality of cartage applications configured to operate on the mobile console and access the database, wherein information produced by a first cartage application may be programmatically consumed by a second cartage application; and
an integrated user interface providing a single point of control for the plurality of cartage applications.

2. The system of claim 1, wherein the cartage data is transmitted and backed up over the network.

3. The system of claim 1, wherein the integrated user interface is accessible to third parties for management purposes, including tracking and dispatching.

4. The system of claim 1, wherein the first cartage application comprises a navigational application, thereby allowing navigational information to be integrated into a second cartage application.

5. The system of claim 1, wherein the second cartage application comprises a reporting application, thereby allowing the information from a first cartage application to be integrated into a report.

6. The system of claim 5, wherein the reporting application is accessible both via the mobile console and to third parties for management purposes.

7. The system of claim 5, wherein the cartage data is editable without generating an audit trail unless required for regulatory purposes.

8. The system of claim 1, wherein the plurality of cartage applications are selected from the group consisting of a navigational module, a logging module, a reporting module, an accounting module, and a management module.

9. The system of claim 1, wherein the peripheral devices are selected from the group consisting of a navigational device, a biometric device, and a printer/scanner.

10. An apparatus for hosting cartage logging and applications, the apparatus comprising:
a mobile console;
a plurality of cartage applications configured to operate on the mobile console and access a database, wherein information produced by a first cartage application may be programmatically consumed by a second cartage application; and
an integrated user interface, providing a single point of control for the plurality of cartage applications.

11. The apparatus of claim 10, wherein the mobile console is selected from the group consisting of a PDA, a smart phone, a notebook computer, and an OEM embedded computer system within a control compartment of a transportation conveyance.

12. The apparatus of claim 10, wherein the mobile console has a capability for substantially hands-free operation.

13. The apparatus of claim 12, wherein the capability for substantially hands-free operation includes a cradle into which the mobile console may be detachably mounted within a control compartment of a transportation conveyance to facilitate access of the integrated user interface by a user while simultaneously operating the transportation conveyance.

14. The apparatus of claim 13, wherein the transportation conveyance is a land vehicle.

15. The apparatus of claim 14, wherein the land vehicle a truck.

16. The apparatus of claim 13, wherein the transportation conveyance is selected from the group consisting of watercraft, aircraft, and spacecraft.

17. The apparatus of claim 12, wherein the capability for substantially hands-free operation is selected from the group consisting of voice recognition, speech synthesis, and thought recognition.

18. The apparatus of claim 10, wherein the mobile console has a touch screen display to capture a signature of a cartage operator to meet reporting requirements and a signature of a customer to enable electronic payment.

19. A method for programmatic transfer of information between cartage applications, comprising the steps of:
receiving input into a first cartage application;
producing information within the first cartage application;
querying a user whether or not to transfer the information to a second cartage application, if user control is required and ending if the user replies not to transfer the information;
consuming the information by the second cartage application;
processing the information by the second cartage application; and
sending output from the second cartage application.

20. A method for hosting cartage logging and applications, comprising the steps of:
providing a mobile console with an integrated user interface providing a single point of control for a plurality of cartage applications, wherein information produced by a first cartage application may be programmatically consumed by a second cartage application;
detachably mounting the mobile console within a control compartment of a transportation conveyance for simultaneous use with the operation of the transportation conveyance while traveling;
reattachably dismounting the mobile console from within a control compartment of a transportation conveyance for extravehicular use while not traveling;
accessing the integrated user interface;
selecting a cartage application; and
running the cartage application thus selected.
